(19) United States
(12) Patent Application Publication
(10) Pub. No.: US 2022/0212716 A1
(43) Pub. Date: Jul. 7, 2022

(54) TORQUE DATA ROBUSTING DEVICE AND METHOD

(71) Applicant: MANDO CORPORATION, Gyeonggi-do (KR)

(72) Inventor: Yeong Jin JEONG, Gyeonggi-do (KR)

(21) Appl. No.: 17/569,501

(22) Filed: Jan. 5, 2022

(30) Foreign Application Priority Data
Jan. 6, 2021 (KR) 10-2021-0001507

(51) Int. Cl. B62D 6/00; B62D 5/04; B62D 15/02

(52) U.S. Cl. CPC B62D 6/00; B62D 15/021; B62D 5/0481

(57) ABSTRACT

The embodiments of the present disclosure relate to a torque data robusting device and method. Specifically, the torque data robusting device according to the present disclosure may include a sensor unit for sensing a speed of a host vehicle, a steering angle and a steering torque for a steering wheel, and a controller configured to generate, if a steering torque value is not received from the sensor unit, a compensation torque to assist an user's steering based on the steering angle and the speed of the host vehicle, determine whether the user's steering is a normal steering or a return steering according to the steering angle and a steering angular velocity, and control to generate and adjust the compensation torque according to the normal steering or the return steering.

### CROSS REFERENCE TO RELATED APPLICATION

This application claims priority from Korean Patent Application No. 10-2021-0001507, filed on Jan. 6, 2021, which is hereby incorporated by reference for all purposes as if fully set forth herein.

### TECHNICAL FIELD

An embodiment of the present disclosure relates to a torque data robusting device and method, more specifically, relates to a torque data robusting device and method which generates a compensation torque based on the sensors mounted on a host vehicle and varies the output according to the user's steering for a plurality of compensation torques.

A power steering of a vehicle is a steering device using power, and serves to assist the driver in manipulating the steering wheel. Although the hydraulic power steering method is mainly used for power steering, the use of an electric power steering (Motor Driven Power Steering: hereinafter collectively referred to as ‘MDPS’) system, which is a method using the power of a motor, is increasing recently.

The MDPS system is a system in which a steering motor for generating auxiliary steering force is separately installed at the lower end of the steering wheel shaft, and in the case that the vehicle is started, the steering motor operates to operate the power steering wheel. Compared to the conventional hydraulic power steering system, the MDPS system has advantages of being light in weight, occupying less space, and requiring no oil change.

The MDPS system facilitates steering by using an auxiliary power source to provide a part of the steering torque that the driver should apply to the steering wheel when steering the vehicle. That is, the driver's steering intention is detected through a torque sensor directly connected to the steering wheel, and the MDPS system receives this signal and drives the motor to provide an appropriate force in consideration of the current vehicle speed, etc., thereby assisting the steering force. The MDPS system reduces the driver's power by assisting a large force when parking, stopping, or driving at a low speed, and maintains the stability of the vehicle by assisting only a small force during high-speed driving.

However, the MDPS system has a disadvantage in that it cannot assist the driver with steering power if the torque sensor detecting the driver's steering intention does not operate properly. In order to overcome this disadvantage, a technology has been developed to assist the driver steer by generating a compensation torque, which is a virtual torque, if the torque sensor fails.

However, as the output is greater, the generated compensation torque acts as an obstacle during reverse steering. In addition, in the case that the steering angle does not change, the compensation torque is fixed and does not change at the same vehicle speed, so there is a problem in that the torque required for steering increases the load on the driver.

### SUMMARY

In this background, embodiments of the present disclosure provide a torque data robusting device and method capable of generating a compensation torque by using sensor information in a state in which a torque value is not received and changing the output of compensation torque according to the user's steering.

In an aspect of the present disclosure, there is provided a torque data robusting device including a sensor unit for sensing a speed of a host vehicle, a steering angle and a steering torque for a steering wheel, and a controller configured to generate, if a steering torque value is not received from the sensor unit, a compensation torque to assist an user's steering based on the steering angle and the speed of the host vehicle, determine whether the user's steering is a normal steering or a return steering according to the steering angle and a steering angular velocity, and control to adjust the compensation torque according to the normal steering or the return steering.

In another aspect of the present disclosure, there is provided a torque data robusting method including sensing, by a sensor unit, a speed of a host vehicle, a steering angle and a steering torque for a steering wheel, generating, if a steering torque value is not received from the sensor unit, a compensation torque to assist an user's steering based on the steering angle and the speed of the host vehicle, determining whether the user's steering is a normal steering or a return steering according to the steering angle and a steering angular velocity, and controlling to adjust the compensation torque according to the normal steering or the return steering.

According to an embodiment of the present disclosure, it is possible to provide a torque data robusting device and method capable of minimizing the user's required steering force by subdividing the compensation torque generated according to the steering angle and the speed of the host vehicle by receiving information from the sensor, determining whether the user's steering is normal steering or return steering, and controlling to generate compensation torque accordingly.

### BRIEF DESCRIPTION OF THE DRAWINGS

FIG. 1 is a diagram for explaining a technology for providing a compensation torque related to the present disclosure.

FIG. 2 is a block diagram of a torque data robusting device according to an embodiment.

FIGS. 3 and 4 are diagrams for explaining the determination of normal steering and return steering according to an embodiment.

FIG. 5 is a diagram exemplarily illustrating an output value of a compensation torque corresponding to a steering angle according to an embodiment.

FIG. 6 is a diagram illustrating a result of applying a torque data robusting device according to an embodiment.

FIG. 7 is a flowchart illustrating a torque data robusting method according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described a technology for providing a compensation torque related to the present disclosure.

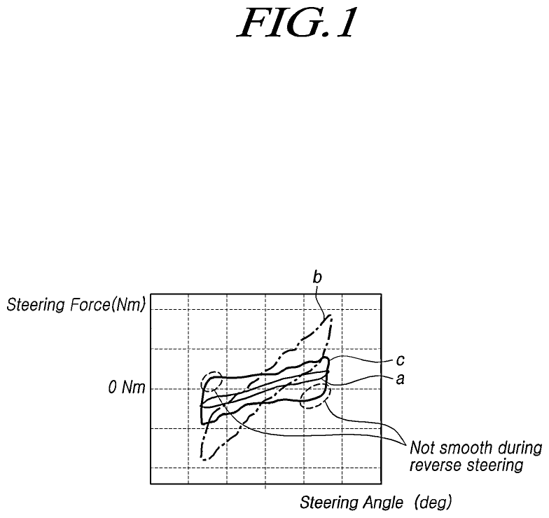

FIG. 1 is a diagram for explaining a technology for providing a compensation torque related to the present disclosure.

Referring to FIG. 1, if the steering force is in a steady state, a torque sensor detects a steering torque according to the user's steering and generates an auxiliary torque, so that the steering force is expressed as a hysteresis curve as shown in FIG. 1A. That is, the auxiliary torque is generated so that it can be steered by a constant steering force at any steering angle. However, in the case that the torque sensor, which is the basis of the auxiliary torque, fails, the steering force is expressed as a hysteresis curve as shown in FIG. 1B. In this case, an appropriate auxiliary torque according to the steering angle is not generated, so that the user feels difficulty in steering.

In order to prevent this situation, the compensation torque compensation technology related to the present disclosure may apply a LOAM (Loss of Assist Mitigation) technology that generates compensation torque using a steering angle and vehicle speed and controls to assist the driver in steering if a torque sensor fails. FIG. 1 (c) illustrates a hysteresis curve to which LOAM is applied. However, in the case that a reverse steering is performed in a LOAM control situation, the larger the output of the compensation torque generated by the LOAM, the more disturbing the reverse steering. Accordingly, the user feels difficulty in steering, thereby degrading the stability of the host vehicle. This is because, if the steering angle does not change, the LOAM compensation torque is fixed and does not change at the same vehicle speed. In addition, the conventional mass production specification has a problem in that the output is lowered due to the above-described problem.

Hereinafter, it will be described a torque data robusting device 10 capable of varying the output of the compensation torque according to normal steering and return steering according to the present disclosure.

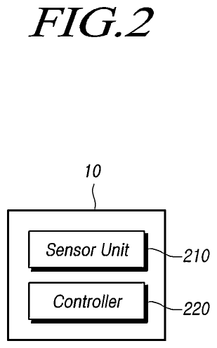

FIG. 2 is a block diagram of a torque data robusting device 10 according to an embodiment.

Referring to FIG. 2, the torque data robusting device 10 may include a sensor unit 210 and a controller 220.

The torque data robusting device 10 may detect a speed of the host vehicle, a rotation angle and a steering torque with respect to a steering wheel. Also, if the steering torque value is not received, the torque data robusting device 10 may generate a compensation torque for maintaining the driving of the host vehicle based on the steering angle and the speed of the host vehicle. In addition, the torque data robusting device 10 may determine whether the user's steering is normal steering or return steering according to the steering angular velocity and the steering angle, and may adjust the compensation torque according to the normal steering or return steering.

The host vehicle may be equipped with the torque data robusting device 10, and through this, may receive a control signal for the host vehicle.

In addition, the torque data robusting device 10 may include sensors capable of detecting the speed of the host vehicle, the rotation angle and the steering torque with respect to the steering wheel.

The sensor unit 210 may detect the speed of the host vehicle, a steering angle with respect to a steering wheel, and a steering torque. Specifically, the sensor unit 210 may include a sensor for detecting the speed of the host vehicle, a steering angle sensor for detecting a rotation angle with respect to the steering wheel, and a torque sensor for detecting a steering torque. Each sensor of the sensor unit 210 may be mounted on the host vehicle, and may acquire information about an object detected by each sensor. Here, the steering angle sensor may detect a displacement of the steering angle that occurs as the driver steers the steering wheel and transmit it to the controller 220. In addition, the torque sensor may detect a torque according to torsion of the torsion bar and transmit it to the controller 220.

In the case that the controller 220 cannot receive the torque value from the sensor unit 210, the controller 220 may generate a compensation torque to assist the user's steering based on the steering angle and the speed of the host vehicle, may determine whether the user's steering is normal steering or return steering according to a steering angle and a steering angular velocity, and may adjust the compensation torque according to the normal steering or return steering. The controller 220 may receive each sensor information from the sensor unit 210 to calculate a compensation torque value. The controller 220 may generate a compensated torque and transmit a control signal for providing the compensation torque according to the calculated compensation torque value to the steering motor.

As described above, by determining whether the user's steering is normal steering or return steering, the torque data robusting device 10 may control the driving direction of the host vehicle with a smaller steering force during return steering.

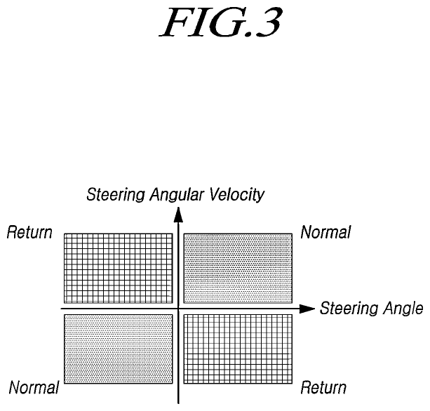

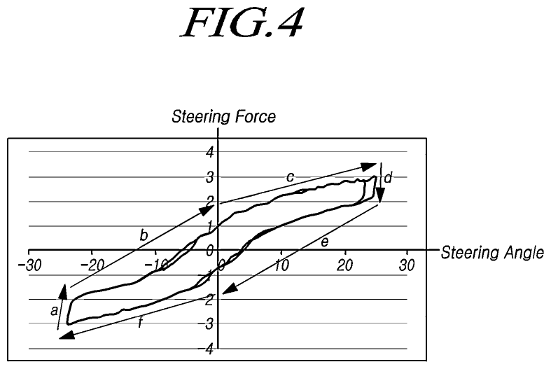

FIGS. 3 and 4 are diagrams for explaining the determination of normal steering and return steering according to an embodiment.

Referring to FIG. 3, the controller 220 may set a steering angle-steering angular velocity domain for determining the return steering and the normal steering according to a steering angle value and a steering angular velocity value. The steering angle-steering angular velocity domain may set four zones based on the steering angle domain and the steering angular velocity domain. If the values of the steering angle and the steering angular velocity correspond to any one of the four zones, the controller 220 may determine the steering (whether return steering or normal steering) corresponding to the corresponding zone.

If the sign of the steering angle and the steering angular velocity are the same, the controller 220 may determine the user's steering as normal steering. For example, if the steering angle is positive and the steering angular velocity is positive, the user's steering may be normal steering. As another example, if the steering angle is negative and the steering angular velocity is negative, the user's steering may be normal steering.

If the sign of the steering angle and the steering angular velocity are different, the controller 220 may determine the user's steering as return steering. For example, if the steering angle is positive and the steering angular velocity is negative, the user's steering may be return steering. As another example, if the steering angle is negative and the steering angular velocity is positive, the user's steering may be return steering.

As described above, the torque data robusting device 10 can clarify the reference for determining the normal steering and the return steering by distinguishing the normal steering from the return steering by using the signs of the steering angle and the steering angular velocity.

FIG. 4 exemplarily illustrates a hysteresis curve for a steering angle and a steering force of the torque data robusting device 10 according to the present disclosure.

Referring to FIG. 4, the controller 220 may determine that the user's steering is return steering if the steering angle changes in a direction approaching neutral as shown in a, b, d, and e of FIG. 4, and may determine the user's steering as normal steering if the steering angle is changed in a direction away from neutral as shown in c and f of FIG. 4.

If it is determined that the user's steering is changed from normal steering to return steering or from return steering to normal steering, the controller 220 may control so that the output of the compensation torque is changed in a ramp manner for a predetermined time. Specifically, referring to FIG. 4, if reverse steering is performed in a state in which the steering angle is deflected to one side, the user's steering may be changed from normal steering to return steering. In this case, the output difference of the compensation torque for normal steering and return steering may occur, so that the user feels difficulty in steering. Accordingly, in the case that the user's steering is changed from the normal steering to the return steering, the controller 220 may control so that the output value of the compensation torque to be changed gradually for a predetermined time instead of immediately changing the compensation torque value of the normal steering to the compensation torque value of the return steering.

As described above, the torque data robusting device 10 controls the compensation torque output difference between the normal steering and the return steering to be output in a ramp method, thereby minimizing the compensation torque gap felt by the user even in a rapid steering situation.

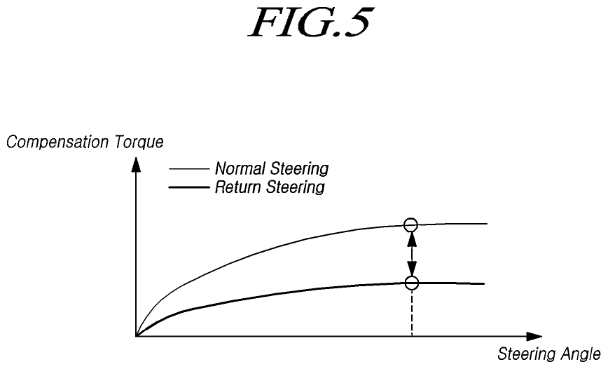

FIG. 5 is a diagram exemplarily illustrating an output value of a compensation torque corresponding to a steering angle according to an embodiment.

Referring to FIG. 5, the controller 220 may control the compensation torque generated when the user's steering is return steering to be smaller than that of normal steering. In sudden steering situations, such as to avoid obstacles ahead, the controller 220 may reduce the steering force required for sudden steering by controlling to generate, during normal steering, a larger compensation torque than the compensation torque output during general return steering.

As described above, the torque data robusting device 10 can achieve the convenience of driving in a situation of sudden steering by controlling to differentially generate compensation torque according to normal steering and return steering.

The controller 220 may control to generate a larger compensation torque as the steering angle increases in a preset steering angle section. The preset steering angle section may be a steering angle section that needs to be compensated with a compensation torque when a user's sudden steering occurs.

As described above, the torque data robusting device 10 may preset the user's sudden steering section, thereby enabling more stable driving when the user's sudden steering occurs.

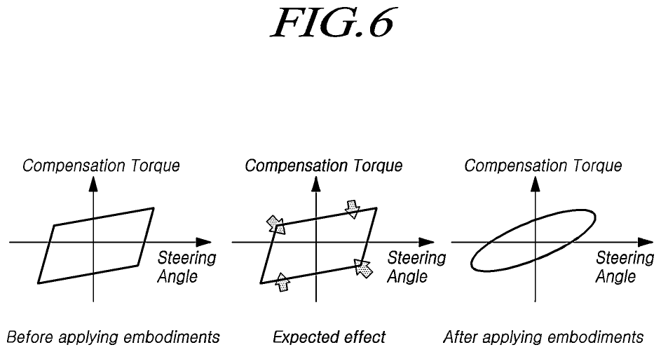

FIG. 6 is a diagram illustrating a result of applying a torque data robusting device 10 according to an embodiment.

Referring to FIG. 6, as the torque data robusting device 10 is applied, the steering force-steering angle hysteresis curve may be implemented similarly to FIG. 1 (a). Accordingly, the user can control the driving direction of the host vehicle with a steering force smaller than before during return steering. In addition, as the LOAM compensation torque can be used larger, the user can control the driving direction of the host vehicle with a smaller steering force than before even under normal steering conditions.

The torque data robusting device 10 of the present disclosure may be implemented as an electronic control unit (ECU). The electronic control unit may include at least one element of one or more processors, memories, storage, user interface inputs and user interface outputs, which may communicate with each other via a bus. Furthermore, the electronic control unit may also comprise a network interface for connecting to the network. The processor may be a CPU or a semiconductor device that executes processing instructions stored in memory and/or storage. Memory and storage may include various types of volatile/non-volatile storage media. For example, memory may include ROM and RAM.

Hereinafter, it will be described a torque data robusting method using the torque data robusting device 10 capable of performing all of the above-described present disclosure.

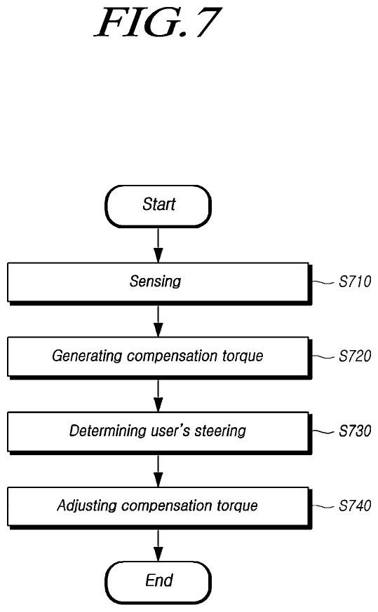

FIG. 7 is a flowchart illustrating a torque data robusting method according to an embodiment of the present disclosure.

Referring to FIG. 7, the torque data robusting method according to the present disclosure may include sensing, by a sensor unit, a speed of a host vehicle, a steering angle and a steering torque for a steering wheel (S710), generating, if a steering torque value is not received from the sensor unit, a compensation torque to assist an user's steering based on the steering angle and the speed of the host vehicle (S720), determining whether the user's steering is a normal steering or a return steering according to the steering angle and a steering angular velocity (S730), and controlling to adjust the compensation torque according to the normal steering or the return steering (S740).

In determining the user's steering (S730), the user's steering may be determined as the normal steering if the signs of the steering angle and the steering angular velocity are the same.

In determining the user's steering (S730), the user's steering may be determined as the return steering if the signs of the steering angle and the steering angular velocity are different.

In adjusting the compensation torque (S740), if it is determined that the user's steering is changed from normal steering to return steering, or from return steering to normal steering, the output of the compensation torque may be controlled to be changed in a ramp method for a predetermined time.

In adjusting the compensation torque (S740), as the steering angle increases in the preset steering angle section, it may be controlled to generate a larger compensation torque.

In adjusting the compensation torque (S740), it may be controlled to generate a smaller compensation torque generated when the user's steering is return steering than when the user's steering is normal steering.

As described above, according to the present disclosure, it is possible to provide a torque data robusting device and method capable of minimizing the user's required steering force by subdividing the compensation torque generated according to the steering angle and the speed of the host vehicle by receiving information from the sensor, determining whether the user's steering is normal steering or return steering, and controlling to generate compensation torque accordingly.

Such a technique for providing a torque data robusting device and method may be implemented in the form of program instructions that may be executed through various computer components and recorded in a computer-readable recording medium. The above-described computer-readable recording medium may include program instructions, data files, data structures, etc. alone or in combination.

The program instructions recorded in the above-described computer-readable recording medium may be those specially designed and configured for the present disclosure, and may be known and used by those skilled in the computer software field.

Examples of the computer-readable recording medium include magnetic media such as hard disks, floppy disks and magnetic tapes, optical recording media such as CD-ROMs and DVDs, magneto-optical media such as floptical disks, and hardware devices specially configured to store and execute program instructions such as ROM, RAM, flash memory, and the like.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A torque data robusting device comprising:
a sensor unit for sensing a speed of a host vehicle, a steering angle and a steering torque for a steering wheel; and
a controller configured to,
generate, if a steering torque value is not received from the sensor unit, a compensation torque to assist an user's steering based on the steering angle and the speed of the host vehicle,
determine whether the user's steering is a normal steering or a return steering according to the steering angle and a steering angular velocity, and
control to adjust the compensation torque according to the normal steering or the return steering.

2. The torque data robusting device of claim 1, wherein the controller determines that the user's steering is the normal steering if the signs of the steering angle and the steering angular velocity are the same.

3. The torque data robusting device of claim 1, wherein the controller determines that the user's steering is the return steering if the signs of the steering angle and the steering angular velocity are different from each other.

4. The torque data robusting device of claim 1, wherein the controller controls an output of the compensation torque to be changed in a ramp method for a predetermined time if it is determined that the user's steering is changed from the normal steering to the return steering, or from the return steering to the normal steering.

5. The torque data robusting device of claim 1, wherein the controller controls to generate a larger compensation torque as the steering angle increases in a preset steering angle section.

6. The torque data robusting device of claim 1, wherein the controller controls the compensation torque to be generated to be smaller in a case that the user's steering is the return steering than a case that the user's steering is the normal steering.

7. A torque data robusting method comprising:
sensing, by a sensor unit, a speed of a host vehicle, a steering angle and a steering torque for a steering wheel;
generating, if a steering torque value is not received from the sensor unit, a compensation torque to assist an user's steering based on the steering angle and the speed of the host vehicle;
determining whether the user's steering is a normal steering or a return steering according to the steering angle and a steering angular velocity; and
controlling to adjust the compensation torque according to the normal steering or the return steering.

8. The torque data robusting method of claim 7, wherein the determining of the user's steering comprises determining that the user's steering is the normal steering if the signs of the steering angle and the steering angular velocity are the same.

9. The torque data robusting method of claim 7, wherein the determining of the user's steering comprises determining that the user's steering is the return steering if the signs of the steering angle and the steering angular velocity are different from each other.

10. The torque data robusting method of claim 7, wherein controlling to adjust the compensation torque comprises controlling an output of the compensation torque to be changed in a ramp method for a predetermined time if it is determined that the user's steering is changed from the normal steering to the return steering, or from the return steering to the normal steering.

11. The torque data robusting method of claim 7, wherein controlling to adjust the compensation torque comprises controlling to generate a larger compensation torque as the steering angle increases in a preset steering angle section.

12. The torque data robusting method of claim 7, wherein controlling to adjust the compensation torque comprises controlling the compensation torque to be generated to be smaller in a case that the user's steering is the return steering than a case that the user's steering is the normal steering.
